(19) United States
(12) Patent Application Publication
(10) Pub. No.: US 2013/0306029 A1
(43) Pub. Date: Nov. 21, 2013

(54) Direct Injection Gas Engine and Method

(71) Applicants: Alan R. Stockner, Metamora, IL (US); Frank J. Lombardi, Metamora, IL (US)

(72) Inventors: Alan R. Stockner, Metamora, IL (US); Frank J. Lombardi, Metamora, IL (US)

(73) Assignee: CATERPILLAR INC., Peoria, IL (US)

(21) Appl. No.: 13/474,109

(22) Filed: May 17, 2012

(51) Int. Cl. F02M 53/04; F02M 69/04

(52) U.S. Cl. 123/445

(57) ABSTRACT

An engine includes an engine having at least one cylinder and a cooling system that circulates coolant. A gaseous fuel system includes a heater and a gaseous fuel injector. Liquefied gaseous fuel is heated by extracting engine heat from the engine coolant and providing it to a stream of liquefied gaseous fuel passing through the heater. Heated gaseous fuel is injected directly into the cylinder. A liquid fuel system having an injector provides liquid fuel directly into the cylinder as ignition source. A sensor measures an outlet coolant temperature from the heater and provides a signal to a controller such that the engine can operate in a normal or in a thermal management mode during which engine heat extracted from the engine coolant is reduced.

### TECHNICAL FIELD

This patent disclosure relates generally to internal combustion engines and, more particularly, to a thermal management operating mode of direct injection diesel and direct injection gas engines.

### BACKGROUND

There are various different types of engines that use more than one fuel. One type is known as a direct injection gas (DIG) engine, in which a gaseous fuel, such as LPG, is injected into the cylinder at high pressure while combustion in the cylinder from a diesel pilot is already underway. DIG engines operate on the gaseous fuel, and the diesel pilot provides ignition of the gaseous fuel. Another type of engine that uses more than one fuel is typically referred to as a dual-fuel engine, which uses a low-pressure gaseous fuel such as natural gas that is mixed at relatively low pressure with intake air admitted into the engine cylinders. Dual-fuel engines are typically configured to operate with liquid fuel such as diesel or gasoline at full power. The gaseous fuel is provided to displace a quantity of liquid fuel during steady state operation. The air/gaseous fuel mixture that is provided to the cylinder under certain operating conditions is compressed and then ignited using a spark, similar to gasoline engines, or using a compression ignition fuel, such as diesel, which is injected into the air/gaseous fuel mixture present in the cylinder.

In dual fuel engines, the gaseous fuel is stored in a pressurized state in a pressure tank, from which it exits in a gaseous state before being provided to the engine. Thus, there is no issue with providing fuel in a gaseous state during engine startup. In DIG engines, however, the gaseous fuel is stored in a liquid state at low pressure, such as atmospheric pressure, and at low, cryogenic temperatures in a liquid storage tank. When exiting the liquid storage tank, the liquefied gaseous fuel requires heating to ultimately evaporate and reach a gaseous state before or when it is provided to the engine cylinders.

The heat required to ultimately help evaporate the liquefied gaseous fuel is typically provided to a stream of liquefied fuel passing through a heat exchanger or heater by using warm coolant from the engine. In this way, engine heat is used to help to ultimately evaporate the liquefied gaseous fuel when the engine is warm. However, when the engine is first started or when operating in frigid climates, the cooling system of the engine may not have sufficient heat to vaporize the liquefied gaseous fuel at a rate that is sufficient to operate the engine at a desired power output. As a consequence, insufficient fuel may be available to operate the engine and, in certain conditions, freezing of the heater and/or other components of the gaseous fuel supply can occur.

One solution proposed in the past for providing liquefied gaseous fuel in a gaseous state to a starting or cold engine involves avoiding the heating of the fuel altogether when insufficient heat is available from the engine. Instead, a limited quantity of fuel is stored in an accumulator in a gaseous, pressurized state in close proximity to the engine. Such accumulators may be filled with gaseous fuel in the gaseous state during a previous warm operation of the engine, and be stored at a high pressure, such as at 200 or 300 bar, until the engine is started. One disadvantage of such systems is that there is a finite quantity of gaseous fuel in the accumulator such that engine operation in this fashion can only be sustained for a limited time, during which the engine may or may not be sufficiently warm to provide the heat required to warm a sufficient amount of liquefied gaseous fuel.

### SUMMARY

In one aspect, the present disclosure describes a direct injection gas engine system. The system includes an engine having at least one cylinder, a cooling system operating to circulate coolant, a gaseous fuel system that includes a heater and a gaseous fuel injector, and a liquid fuel system that includes a liquid fuel injector. The heater of the gaseous fuel system is adapted to heat liquefied gaseous fuel by extracting engine heat from the engine coolant and providing the engine heat to a stream of liquefied gaseous fuel passing through the heater. The liquefied gaseous fuel heats into a supercritical gaseous state, which the injector is adapted to directly into the cylinder. The liquid fuel injector is configured to inject liquid fuel directly into the cylinder.

In one embodiment, a coolant temperature sensor is disposed to measure an outlet coolant temperature from the heater and provide an outlet coolant temperature signal. A controller is disposed to control the gaseous fuel and the liquid fuel injectors, and is further disposed to receive and process the outlet coolant temperature signal. During operation, when the outlet coolant temperature signal is above a threshold temperature, the controller commands a normal amount of liquid fuel and a normal amount of gaseous fuel to be injected into the cylinder during a normal engine operating mode. When the outlet coolant temperature signal is at or below the threshold temperature, the controller commands an amount of liquid fuel that is larger than the normal amount of liquid fuel and an amount of gaseous fuel that is less than the normal amount of gaseous fuel to be injected into the cylinder, such that the engine heat extracted from the engine coolant is reduced during an engine thermal management mode.

In another aspect, the disclosure describes a thermal management system for a direct injection gas engine, which uses a diesel pilot to ignite a directly injected gaseous fuel such as liquefied petroleum or natural gas that is stored in a cryogenic tank and is heated in a heater for use in an engine. In one embodiment, the heater operates to extract heat from engine coolant, and to provide that heat to the gaseous fuel. The thermal management system operates in a controller associated with the engine, and includes a diesel fuel system, which includes a diesel fuel rail in fluid communication with a diesel fuel injector configured to inject diesel fuel directly into an engine cylinder, and a gaseous fuel system, which includes a gaseous fuel injector configured to inject gaseous fuel directly into the engine cylinder.

In one embodiment, a coolant temperature sensor is disposed to measure a temperature of engine coolant at a coolant outlet of the heater and provide an outlet coolant temperature signal to a controller. The controller is disposed to receive and process the outlet coolant temperature signal and, based on the outlet coolant temperature signal, control the gaseous fuel and the liquid fuel injectors such that, when the outlet coolant temperature signal is above a threshold temperature, the controller commands a normal amount of liquid fuel and a normal amount of gaseous fuel to be injected into the cylinder during a normal engine operating mode. When the outlet coolant temperature signal is at or below the threshold temperature, the controller commands an amount of liquid fuel that is larger than the normal amount of liquid fuel and an amount of gaseous fuel that is less than the normal amount of gaseous fuel to be injected into the cylinder, such that the engine heat extracted from the engine coolant is reduced during an engine thermal management mode.

In yet another aspect, the disclosure describes a method for managing thermal energy in a direct injection gas engine. The method includes operating a gaseous fuel supply system that includes a storage tank adapted to store a gaseous fuel in a cryogenically liquefied state, a gas pump adapted to draw gaseous fuel from the storage tank and compress it to produce compressed gaseous fuel, a heater adapted to increase an enthalpy of the compressed gaseous fuel by supplying heat extracted from an engine cooling system to the gaseous fuel, and a gaseous fuel rail adapted to collect the compressed gaseous fuel. A controller monitors sensor signals indicative of a heating power that is provided to the gaseous fuel through the heater. The sensor signals include at least one of a coolant inlet temperature to the heater, a coolant outlet temperature from the heater, an engine speed and an engine load. When the controller determines that the heat extracted from the engine is insufficient to increase the enthalpy of the compressed gaseous fuel based on the monitoring of at least one of the sensor signals, engine operation is shifted from a normal mode to a thermal management mode. When operating in the normal mode, a normal amount of a liquid fuel and a normal amount of the gaseous fuel are injected into an engine cylinder to produce a rated engine power. When operating in the thermal management mode, an amount of liquid fuel that is larger than the normal amount of liquid fuel and an amount of gaseous fuel that is less than the normal amount of gaseous fuel are injected into the engine cylinder to produce and engine power that is less than or equal to the rated power.

### BRIEF DESCRIPTION OF THE DRAWINGS

FIG. 1 is a block diagram of a direct injection gas and liquid fuel system for an engine in accordance with the disclosure.

FIG. 2 is a cross section of an engine cylinder in accordance with the disclosure.

FIG. 3 is a block diagram for a controller in accordance with the disclosure.

FIG. 4 is a flowchart of a thermal controller in accordance with the disclosure.

FIG. 5 is a flowchart of a first embodiment for a thermal controller determination in accordance with the disclosure.

FIG. 6 is a flowchart of a second embodiment for a thermal controller determination in accordance with the disclosure.

FIG. 7 is a flowchart for a method of operating an engine during a thermal management operating mode in accordance with the disclosure.

### DETAILED DESCRIPTION

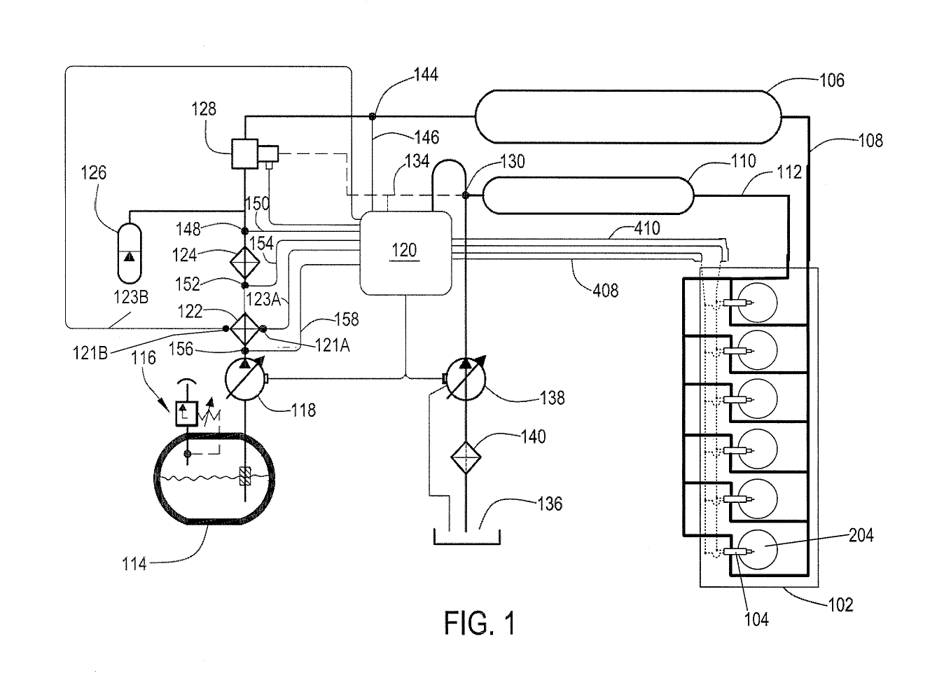

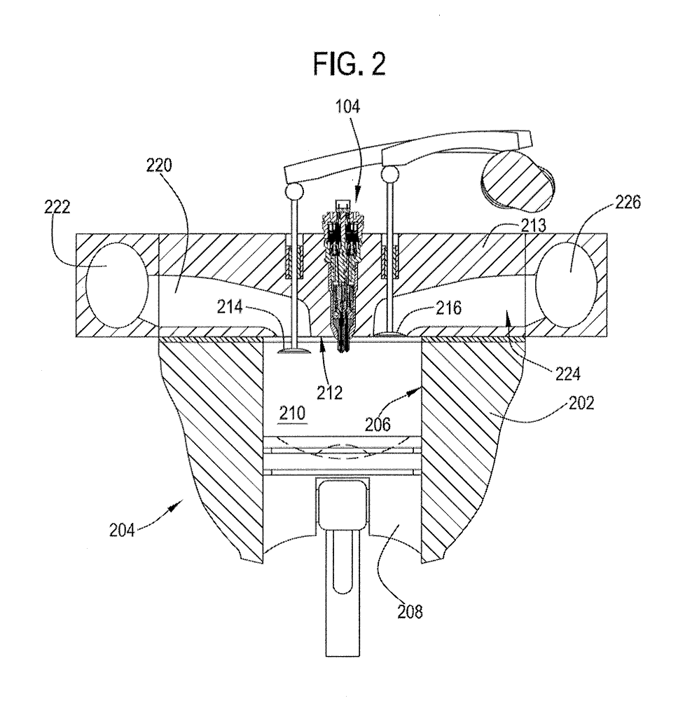

This disclosure relates to direct injection gas (DIG) engines using diesel ignition and, more particularly, to an engine control strategy and system for adjusting engine operation while the engine is warming up and/or the engine is operating in frigid ambient temperature conditions. A block diagram of a DIG engine system 100 is shown in FIG. 1. The engine system 100 includes an engine 102 (shown generically in FIG. 1) having a fuel injector 104 associated with each engine cylinder (best shown in FIG. 2). The fuel injector 104 is a dual-check injector configured to independently inject predetermined amounts of two separate fuels.

The injector 104 is connected to a high-pressure gaseous fuel supply line 108 and to a high-pressure liquid fuel rail 110 via a liquid fuel supply line 112. In the illustrated embodiment, the gaseous fuel is natural or petroleum gas that is provided through the gaseous fuel supply line 108 at a pressure of between about 25-50 MPa, and the liquid fuel is diesel, which is maintained within the liquid fuel rail 110 at about 25-50 MPa, but any other pressures or types of fuels may be used depending on the operating conditions of each engine application. It is noted that although reference is made to the fuels present in the supply line 108 and the fuel rail 110 using the words “gaseous” or “liquid,” these designations are not intended to limit the phase in which is fuel is present in the respective rail and are rather used solely for the sake of discussion. For example, the fuel provided at a controlled pressure within the gaseous fuel supply line 108, depending on the pressure at which it is maintained, may be in a liquid, gaseous or supercritical phase. Additionally, the liquid fuel can be any hydrocarbon based fuel; for example DME (Di-methyl Ether), biofuel, MDO (Marine Diesel Oil), or HFO (Heavy Fuel Oil).

Whether the system 100 is installed in a mobile or a stationary application, each of which is contemplated, the gaseous fuel may be stored in a liquid state in a cryogenic tank 114, which can be pressurized at a relatively low pressure, for example, atmospheric, or at a higher pressure. In the illustrated embodiment, the tank 114 is insulated to store liquefied natural gas (LNG) at a temperature of about −160° C. (−256° F.) and a pressure that is between about 100 and 1750 kPa, but other storage conditions may be used. The tank 114 further includes a pressure relief valve 116.

During operation, LNG from the tank is compressed, still in a liquid phase, in a pump 118, which raises the pressure of the LNG while maintaining the LNG in a liquid phase. The pump 118 is configured to selectively increase the pressure of the LNG to a pressure that can vary in response to a pressure command signal provided to the pump 118 from an electronic controller 120. Although the LNG is present in a liquid state in the tank, the present disclosure will make reference to compressed or pressurized LNG for simplicity when referring to LNG that is present at a pressure that exceeds atmospheric pressure.

Accordingly, the compressed LNG is heated in a heat exchanger 122. The heat exchanger 122 provides heat to the compressed LNG to reduce density and viscosity while increasing its enthalpy and temperature. In one exemplary application, the LNG may enter the heat exchanger 122 at a temperature of about −160° C., a density of about 430 kg/m³, an enthalpy of about 70 kJ/kg, and a viscosity of about 169 μPa s as a liquid, and exit the heat exchanger at a temperature of about 50° C., a density of about 220 kg/m³, an enthalpy of about 760 kJ/kg, and a viscosity of about 28 μPa s. It should be appreciated that the values of such representative state parameters may be different depending on the particular composition of the fuel being used. In general, the fuel is expected to enter the heat exchanger in a cryogenic, liquid state, and exit the heat exchanger in a supercritical gas state, which is used herein to describe a state in which the fuel is gaseous but has a density that is between that of its vapor and liquid phases. The heat exchanger 122 may be any known type of heat exchanger or heater for use with LNG. In the illustrated embodiment, the heat exchanger 122 is a jacket water heater that extracts heat from engine coolant. In alternative embodiments, the heat exchanger 122 may be embodied as an active heater, for example, a fuel fired or electrical heater, or may alternatively be a heat exchanger using a different heat source, such as heat recovered from exhaust gases of the engine 102, a different engine belonging to the same system such as what is commonly the case in locomotives, waste heat from an industrial process, and other types of heaters or heat exchangers. In the embodiment shown in FIG. 1, which uses engine coolant as the heat source for the heat exchanger 122, a temperature sensor 121 is disposed to measure the temperature of engine coolant exiting the heat exchanger 122 and provide a temperature signal 123 to the controller 120.

Gas exiting the heat exchanger 122 is filtered at a filter 124. A portion of the filtered gas may be stored in a pressurized accumulator 126, and the remaining gas is provided to a pressure control module 128. Pressure-regulated gas is provided to the gaseous fuel supply line 108. The pressure control module 128 is responsive to a control signal from the electronic controller 120 and/or is configured to regulate the pressure of the gas provided to the fuel injector 104. The pressure control module 128 can be a mechanical device such as a dome loaded regulator or can alternatively be an electromechanically controlled device that is responsive to a command signal from the controller 120.

Liquid fuel, or in the illustrated embodiment diesel fuel, is stored in a fuel reservoir 136. From there, fuel is drawn into a variable displacement pump 138 through a filter 140 and at a variable rate depending on the operating mode of the engine. The rate of fuel provided by the pump 138 is controlled by the pump's variable displacement capability in response to a command signal from the electronic controller 120. Pressurized fuel from the pump 138 is provided to the liquid fuel rail 110.

The system 100 may include various other sensors providing information to the controller 120 relative to the operating state and overall health of the system. For instance, the system 100 may include various other sensors that are indicative of the state of the gaseous fuel at various locations in the system. The gas state thus indicated may be based on a direct measurement of a parameter or on a so called “virtual” measurement of a parameter, which relative to this disclosure means a determination of a parameter that is inferred based on another directly measured parameter having a known or estimated relationship with the virtually measured parameter. As used herein, gas state is meant to describe a parameter indicative of the thermodynamic state of the gaseous fuel, for example, the pressure and/or temperature of the fuel, as appropriate. When determining the state of the gas, the parameter of interest for purpose of diagnosing the health of the system depends on changes that may occur to the state of the gas. Accordingly, while pressure of the gas may be relevant to diagnosing the operation of a pump, the temperature of the gas may be more relevant to diagnose the operating state of a heat exchanger that heats the gas. In the description that follows, reference is made to “state” sensors, which should be understood to be any type of sensor that measures one or more state parameters of the gas, including but not limited to pressure, temperature, density and the like.

Accordingly, a gas state sensor 144 is disposed to measure and provide a rail state signal 146 indicative of a fluid state at the gas fuel supply line 108. The rail state signal 146 may be indicative of pressure and/or temperature of the gas. A state sensor 148 is disposed to measure and provide a filter state signal 150 indicative of the gas state between (downstream of) the gas filter 124 and (upstream of) the pressure control module 128. The filter state signal 150 may be indicative of gas pressure. An additional state sensor 152 is disposed to measure and provide a heater state signal 154 indicative of the gas state between the heat exchanger 122 and the gas filter 124. The heater state signal 154 may be indicative of gas temperature at that location. An additional state sensor 156 is disposed to measure and provide a liquid state signal 158 at the outlet of the pump 118. The liquid state signal 158 at the outlet of the pump 118 may be indicative of gas pressure, for purpose of diagnosing pump operation, and/or gas temperature, for purpose of comparing to the heater state signal 154 downstream of the heat exchanger 122 for diagnosing the operating state of the heat exchanger 122. The rail state signal 146, filter state signal 150, heater state signal 154, liquid state signal 158, and/or other state signals indicative of the fluid state for the liquid/gaseous fuel are provided to the electronic controller 120 continuously during operation.

The electronic controller 120 includes functionality and other algorithms operating to monitor the various signals provided by system sensors and detect various failure or abnormal operating modes of the system 100 such that mitigating actions can be taken to promote engine warming after a cold engine start and/or steady engine operation in frigid conditions, for example, where ambient air temperature is at or below −20° C. In other words, the controller 120 includes a system temperature control system for the DIG engine system 100 that can detect and address temporary or permanent thermal energy-related issues in the fuel system, especially those issues that may arise during a cold engine start or engine operation at low ambient temperature conditions. Apart from cold engine starts and operation in frigid ambient air temperature conditions, other examples of abnormal operating conditions associated with thermal energy-related issues can include water ingress and freezing issues with various fuel system components, conditions in which excess thermal energy is present, for example, when the system operates at high ambient air temperature conditions, clogging of any of the filters, freezing and/or clogging of the heat exchanger 122, malfunction of the pressure control module 128, and/or other conditions that specifically relate to the supply of the compressed gas to and from gaseous fuel supply line 108.

During normal operation, gaseous and liquid fuel are independently injected at high pressure into engine cylinders through the fuel injector 104. A cross section of one embodiment for the injector 104 is shown installed in an engine cylinder 204 in FIG. 2. Although the injector 104 shown in these figures has two checks arranged side by side, any other fuel injector design is suitable, for example, dual injectors having concentric checks or needle valves. In reference now to the figures, each engine cylinder 204 includes a bore 206, which is formed within a cylinder block 202 and slidably accepts therewithin a piston 208. As is known from typical engine applications, pistons can be connected to an engine crankshaft (not shown), which operates to provide a force tending to move each piston within the cylinder bore, for example, during a compression stroke, as well as can be moved by a force applied by the piston to rotate the crankshaft, for example, during a combustion or power stroke.

The cylinder 204 defines a variable volume 210 that, in the illustrated orientation, is laterally bound by the walls of the bore 206 and is closed at its ends by a top portion or crown of the piston 208 and by a surface 212 of the cylinder head 213, which is typically referred to as the flame deck. The variable volume 210 changes between maximum and minimum capacity as the piston 208 reciprocates within the bore 206 between bottom dead center (BDC) and top dead center (TDC) positions, respectively.

In reference to FIG. 2, each cylinder 204 includes at least one intake valve 214 and at least one exhaust valve 216. It is noted that, although the cylinder 204 is illustrated in a fashion consistent with an engine operating under at least a four-stroke cycle, and thus includes cylinder intake and exhaust valves, other types of engines such as two-stroke engines are contemplated but are not specifically illustrated for brevity. In the particular engine illustrated in FIG. 2, the intake and exhaust valves 214 and 216 are selectively activated to fluidly connect the variable volume 210 with sinks and sources of fluids during operation of the engine 102. Specifically, the intake valve 214 selectively blocks an intake passage 220 that fluidly interconnects the variable volume 210 with an intake manifold 222. Similarly, the exhaust valve 216 selectively blocks an exhaust passage 224 that fluidly interconnects the variable volume 210 with an exhaust manifold 226. In the illustrated embodiment, the fuel injector 104 is disposed to selectively inject diesel and compressed natural gas (CNG) fuel directly into the variable volume 210 of each engine cylinder 204.

It is noted that although a single injector that is configured to independently inject two fuels is shown herein, it is contemplated that two injectors, one corresponding to each of the two fuels, may be used instead of the single injector. Alternatively, a fuel injector having concentric needles can be used. Thus, the injector 104 represents one of numerous possible embodiments of injectors configured to independently inject two types of fuel. The specific embodiment of the injector 104 uses diesel fuel pressure to activate the check valve for injecting gaseous fuel, even though both fuels may be provided to the injector at about the same pressure, which in the illustrated embodiment is between 25 and 50 MPa.

Under normal operating conditions, the injector 104 is configured to selectively inject diesel or gas during engine operation. In the illustrated embodiment, the total fuel energy supply of the engine during normal operation is made up by an energy contribution of about 3-10% by the diesel fuel and the remaining 90-97% of the total fuel energy supply by the gaseous fuel. The specific displacement ratio of gas with diesel may vary depending on the particular operating point of the engine. These fuels are injected at different times during engine operation. For example, diesel may be injected first, for example, while the piston 208 is moving towards the TDC position as the cylinder 204 is undergoing or is close to completing a compression stroke. When combustion of the diesel fuel in the variable volume is initiated or is about to initiate, the injector 104 causes gas at a high pressure to be injected directly into the cylinder 204 and combust as it is lit by the combusting diesel fuel.

When an abnormal operating condition is present that diminishes the ability of the system 100 (FIG. 1) to provide a sufficient amount of gaseous fuel to operate the engine, for example, when the engine has not been sufficiently warmed to provide sufficient thermal energy to heat an amount of liquefied gaseous fuel that is required under the then present engine operation condition, the controller 120 activates a thermal-energy management operating mode. During the thermal-energy management operating mode, various engine parameters are adjusted to enable stable engine operation while operating on diesel fuel only or a combination of diesel and gaseous fuel. In this mode, the rate of heating of liquefied gaseous fuel, and thus the thermal-energy required for this heating, is reduced or metered to a predetermined rate such that sufficient energy is left to warm up the engine. When reducing the amount of gaseous fuel used, the controller 120 may reduce the pressure of gaseous fuel that is available to the engine and/or reduce the injection duration for the gaseous fuel.

In one embodiment, the metering of thermal energy consumed during heating of the liquefied gaseous fuel, which energy will be referred to as gas heating energy, is determined and then controlled based on a target coolant outlet temperature of the heater. In an alternative embodiment, a type of thermal balance calculation can be performed within the controller 120. Such thermal balance calculation can be based on various parameters and encompasses the energy input to the heater, which is determined based on the engine coolant inlet and outlet temperatures, on ambient air temperature, which can be determined by use of typical engine sensors and/or by a dedicated surface temperature sensor disposed on the heater, and on a flow-rate and temperature of the liquefied gaseous fuel passing through the heater or, alternatively, the temperature and flow rate of gaseous fuel used by the engine. Any of these parameters may be measured directly or inferred based on other parameters. For example, the flow rate of gaseous fuel used by the engine may be measured by use of a flow meter, or may be inferred in any number of ways, including a fuel rate commanded to the controller 120 in conjunction with engine speed, a fluid pressure at the outlet of the pump 118 in conjunction with a displacement and speed of the pump 118, a gas pressure in the gaseous fuel rail 106 in conjunction with an injection duration of gas through the injector 104, or by any other appropriate method.

When operating in a reduced heating energy mode, the controller 120 may increase the liquid or diesel fuel supply to the engine cylinders to compensate for the reduction in availability of gaseous fuel, if the total engine power is to remain unchanged. Alternatively, or in addition, the controller 120 may limit the total available engine power when operating in this mode if, for example, the liquid fuel system's ability to increase the liquid fuel supply injected into the engine cylinder is at or nearing saturation. This is because, unlike traditional dual-fuel engines, which are normally capable of operating at full power using either of the two fuels available, the operation of certain DIG engine systems requires adjustments to enable any appreciable power contribution by combustion of the liquid fuel.

In general, the diesel or liquid fuel system of a DIG engine, which typically is only called upon to provide a pilot fuel capability that lights off the gaseous fuel, is sized in the illustrated embodiment to permit engine operation under at least some power provided by combustion of diesel fuel. Depending on the extent of heating energy reduction that is determined in the controller 120, engine operation may be carried out by using an amount of gaseous fuel that is less than what would normally be required. In extreme conditions, for example, a cold engine start in frigid ambient air conditions, there may temporarily be no thermal energy available for heating the gaseous fuel because engine coolant temperature is low enough to lead to freezing of the engine coolant within the heater 122 (FIG. 1) if any heating were attempted. It should be appreciated that engine coolant freezing within the heater should be avoided to avoid damage of the heater and/or plugging of a portion of the engine cooling system. To avoid this condition, the engine is advantageously capable of providing a predetermined power output while operating entirely on the liquid fuel. This functionality is accomplished both by software algorithms operating within an engine controller, as well as by various hardware capabilities of various engine components and systems.

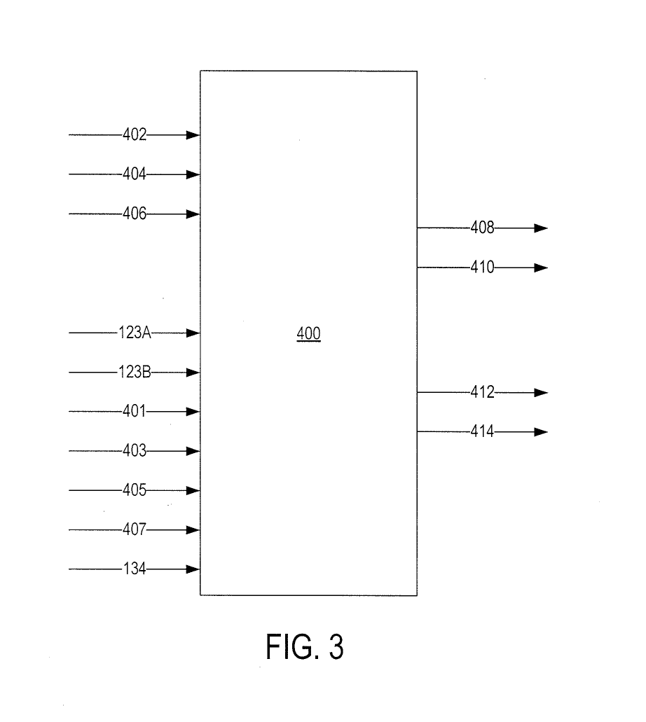

A block diagram of a thermal management controller 400 is shown in FIG. 3. The controller 400 may be embodied as part of a computer having tangible storage media with computer executable instructions stored thereon that operate in a computer processor. The controller 400 may alternatively be embodied as a hardware controller or any other appropriate type of control device that operates either on-board on a vehicle or remotely.

In the illustrated embodiment, the controller 400 is disposed to receive signals from various sensors associated with the system 100 (FIG. 1), process information based on the sensor signals, and provide commands to control the operation of various components and systems of the engine 102 (FIG. 1), as appropriate. For example, the controller 400 shown in FIG. 3 is disposed to receive engine speed and load signals 402 and 404, respectively, that are indicative of desired engine operating conditions. The speed and load signals 402 and 404 may be based on operator commands or may alternatively be provided by an engine controller that controls the operation of the engine. The controller 400 further receives an optional engine timing signal 406, for example, provided by a crankshaft or camshaft sensor (not shown) of the engine 102 in the known fashion, which may be a separate signal or may alternatively be part of the engine speed signal 402 already discussed.

During operation, the controller 400 receives signals indicative of the operating state of the gaseous fuel delivery system and the engine 102 to assess the operating health of those systems and address any thermal issues that may arise. More specifically, and in parallel reference to FIG. 1, the controller 400 may receive the heater outlet temperature 123, and may further receive a heater inlet temperature (not shown), which may be acquired at the heater or elsewhere in the cooling system. For simplicity, the heater coolant inlet temperature is denoted as 123A, and the heater coolant inlet temperature is denoted as 123B in FIG. 3. Although both inlet and outlet temperatures are discussed relative to FIG. 3, the inlet temperature is optional and may be omitted. The controller may further receive signals from other engine or fuel system sensors such as an ambient air temperature 401, an engine oil temperature 403, an engine coolant temperature 405, a position 407 of the gaseous fuel pump 118, the pressure of gas in the gaseous fuel rail 134, and/or other signals, all of which are optional and may be omitted.

In addition to receiving information about the operating state of the engine system 100, the controller 400 is configured to provide command signals that control the operation of various fuel-related components and systems of the engine system 100. More specifically, the controller 400 provides diesel and gaseous fuel commands 408 and 410 respectively (also see FIG. 1) to the fuel injector 104. Each fuel command 408 and 410 provides an electrical signal to a respective injector actuator that has a predetermined duration, during which the respective fuel is injected from the injector 104.

The controller 400 further provides signals controlling or setting the displacement of the diesel pump 138 and the LNG pump 118, and setting a desired rail pressure of the gaseous fuel through the pressure control module 128. More specifically, a diesel pump control signal 412 and a gaseous fuel pump control signal 414 are determined in the controller 400 and provided to the respective pumps to control the displacement and, thus, the amount of fuel each pump 118 and 138 provides during operation. The determinations within the controller 400 for commanding fuel injection through fuel commands 408 and 410 and pumping commands 412 and 414, in one embodiment, are based at least on the outlet coolant temperature 123A, as well as on the other optional inputs, if present.

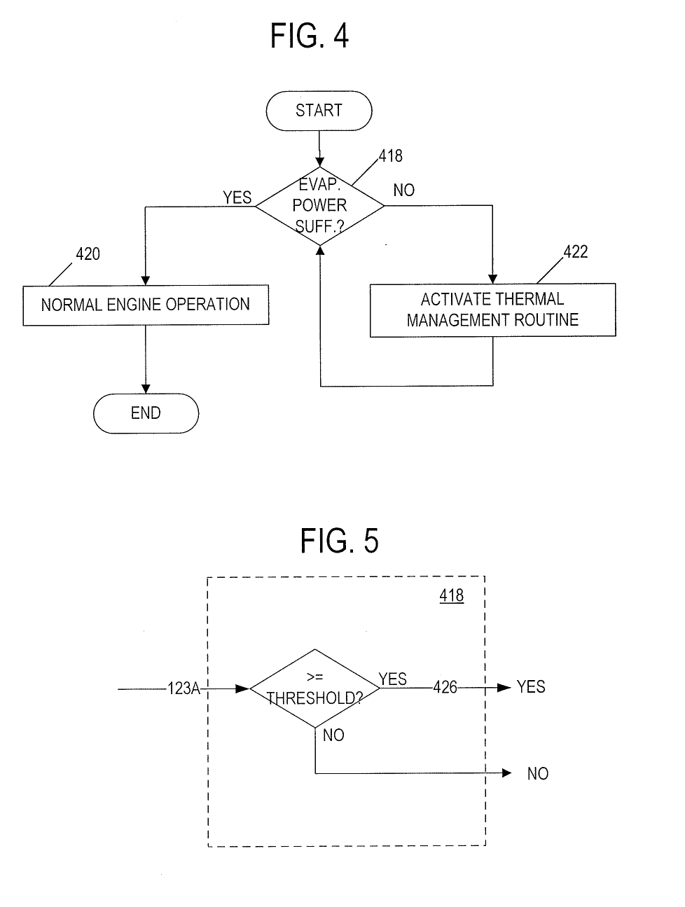

A flowchart of a method for operating the controller 400 is shown in FIG. 4. In this embodiment, thermal control of the engine and the heating of the liquefied gaseous fuel is performed based on a comparison at 418 between the thermal requirements at the heater to gasify liquefied fuel at a sufficient rate to operate the engine at a desired condition, and the thermal requirements to warm an engine after a cold start and/or during operation in frigid ambient conditions. When the controller 400 determines that the engine is able to provide sufficient heat energy to the heater, normal engine and fuel system operation is carried out at 420. When the heat energy that is required to operate the engine exceeds the thermal capability of the engine, a thermal management routine is activated at 422, and the process repeats with successive determinations at 418.

It is contemplated that, under some conditions, for example, when the engine is able to achieve warm operation, use of the thermal management routine will be temporary. Under certain other conditions, for example, when the engine operates in a frigid environment without auxiliary devices to aid warm the engine, the thermal management routine at 422 may be active for prolonged periods. It is, therefore, contemplated that the engine is configured to provide useful power for various applications even when operating at the thermal management mode.

A block diagram for a first embodiment of the determination at 418 of whether sufficient thermal energy is available to gasify adequate fuel to operate the engine normally is shown in FIG. 5. In this embodiment, the controller 400 uses a target coolant temperature at the outlet of the heater or, as shown in FIG. 1, the outlet temperature 123A, to determine the thermal energy state of the system. In this way, the controller 400 is configured to monitor the heater coolant outlet temperature at 424 to determine whether it is at or above a threshold value, for example, a temperature that indicates that a particular type of coolant is close to freezing. When the heater coolant outlet temperature is at or above the threshold temperature, which is an indication that the engine is operating at a sufficiently warm temperature, an indication is given at 426 that normal engine operation can be carried out at 420 (FIG. 3). When the heater coolant outlet temperature is below the threshold temperature, the thermal management routine is activated at 422 (FIG. 4).

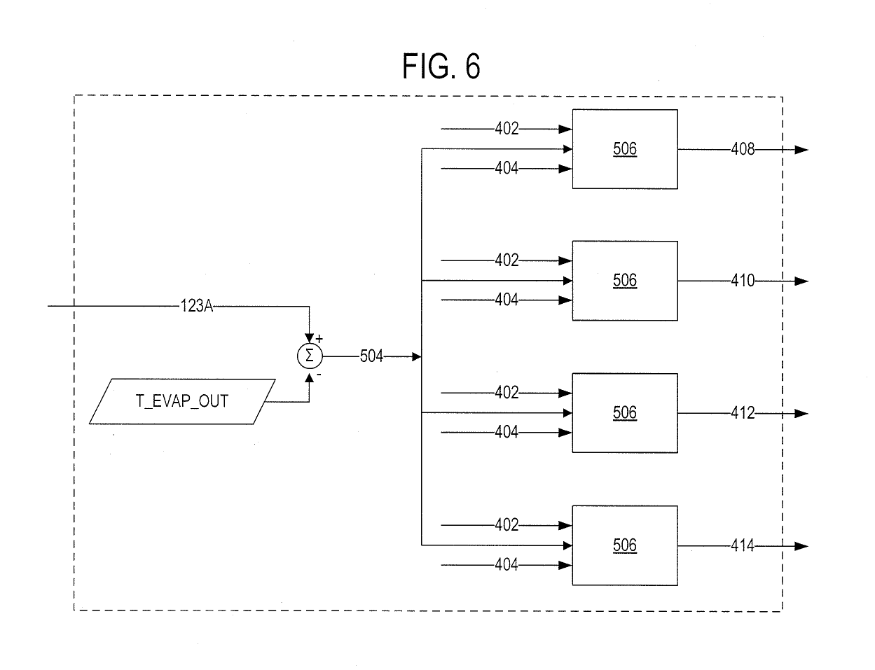

A block diagram of one embodiment for a thermal management routine 500 such as the one activated at 422 (FIG. 4) is shown in FIG. 6. The thermal management routine 500 accepts as an input the heater outlet coolant temperature 123A, which is presumed here to be below a target or threshold temperature, T_EVAP_OUT. A difference between the heater outlet coolant temperature 123A and the threshold temperature T_EVAP_OUT is calculated at 502 to provide a difference value 504. As shown, the difference value 504 is a positive value that is indicative of the magnitude of the difference of the two parameters. The difference value 504 is provided to four functions, each of which provides an output parameter of the controller 400 (FIG. 3) that is correlated to the difference value 504 in a predetermined fashion. More specifically, and in parallel reference to FIG. 3, a diesel injection function 506 provides the diesel fuel command 408, a gas injection function 508 provides the gaseous fuel command 410, a diesel pump function 510 provides the diesel pump control signal 412, and a gas pump function 512 provides the gaseous fuel pump control signal 414.

In the illustrated embodiment, each of these functions 506, 508, 510 and 512 is embodied as a three-dimensional lookup table function that correlates the temperature difference value 504 with commanded engine speed 402 and commanded engine load 404. In alternative embodiments, one or more of functions 506, 508, 510 and 512 can be embodied in any other active form, such as a proportional, integral and derivative (PID) type controller, model-based algorithm and the like, or a passive form, such as one or more one- or two-dimensional lookup tables or other function types. Additionally, each function 506, 508, 510 and 512 can receive additional engine or system parameters to be used in the determination of the respective command parameter. Such additional engine or system parameters can include one or more of the ambient air temperature 401, an engine oil temperature 403, an engine coolant temperature 405, a position 407 of the gaseous fuel pump 118, the pressure of gas in the gaseous fuel rail 134, and/or other signals that can be correlated to the operation of the engine in terms of heat. Further, the temperature difference value may drive a single function having a correction factor as its output. In such embodiment, the correction factor may be used elsewhere in the controller 120 (FIG. 1) to modify or scale the various command signals that are relevant to the control and operation of the system 100 (FIG. 1).

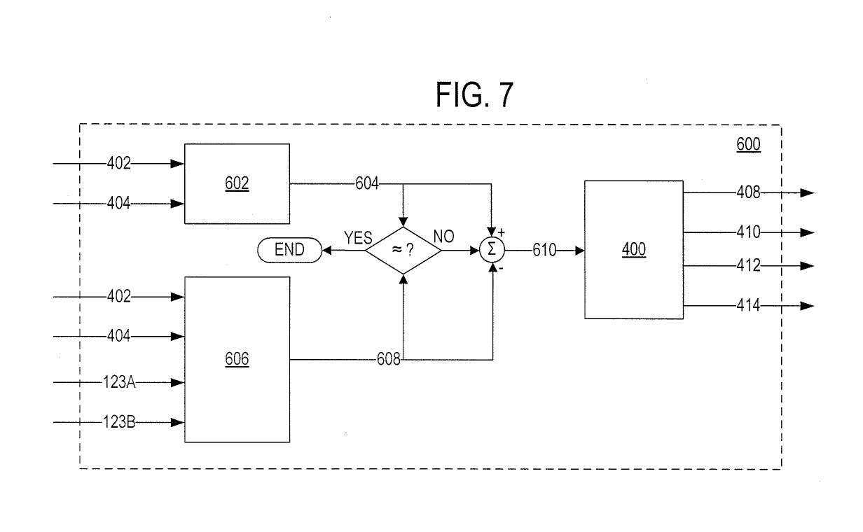

A block diagram of an alternative embodiment for a thermal management routine 600 such as the one activated at 422 (FIG. 4) is shown in FIG. 7. The thermal management routine 600 includes an expected heating energy calculation function 602 that operates to calculate, in real time, the thermal power, for example, in kW, that is required to heat liquefied gaseous fuel at a rate sufficient for normal engine operation. In the illustrated embodiment, the heating energy calculation function 602 receives the engine speed 402 and engine load 404 signals and by assuming or measuring various state parameter information for the liquefied gas, such as temperature and pressure, determines an expected heating power parameter 602, which is indicative of the thermal power that is required to heat sufficient gaseous fuel to operate the engine at a given speed and load condition.

The thermal management routine 600 further includes a measured heat calculation function 606, which determines, in real time, the thermal power that is actually absorbed by the gaseous fuel at the heater. The measured heat calculation function 606 receives the engine speed 402, as an indication of coolant flow rate through the heater, the engine load 404, as an indication of the gaseous fuel flow rate through the heater, and the coolant outlet temperature 123A of the heater, as an indication of the enthalpy increase in the gaseous fuel. The measured heat calculation function 606 provides a measured power parameter 608, which is indicative of the actual thermal power being absorbed by the gaseous fuel as the engine operates at the given speed and load.

The thermal management routine 600 then compares the expected to the measured power parameters 604 and 608 at a comparator 610 to determine whether the two powers are substantially equal. When the engine is warm, and sufficient thermal power is available to heat liquefied gaseous fuel at a sufficient rate, the expected and measured power parameters 604 and 608 will substantially match and the engine will be operating in a normal mode. However, if the measured power is less than the expected power, for example, if the engine coolant is not warm enough to supply the expected thermal power, such as when the engine thermostat is closed, the engine is cold, there is insufficient coolant flow through the heater, or the like, the management routine 600 will work to reduce the expected power to substantially match or be less than the measured power.

In one embodiment, reducing the heating power is accomplished by altering the fueling and other commands of the engine to increase the use of liquid fuel and decrease the amount of gaseous fuel provided. In some embodiments, the increase of liquid fuel use can be accomplished, for example, by commanding the liquid fuel pump to increase the liquid fuel rail pressure and/or by increasing the liquid fuel injection duration. Similarly, use of gaseous fuel can be decreased, for example, by decreasing the gaseous fuel injection pressure. In the illustrated embodiment, a power difference 610 between the expected and measured heating power is calculated at 612. The power difference 610 is provided to a shift function 614, which operates to shift engine operation by increasing liquid fuel and decreasing gaseous fuel consumption of the engine gradually and based on the power difference 610. In other words, the larger the power difference 610 is determined to be, the greater the shift in engine operation is commanded. The shift function 614 provides as outputs the main engine control parameters discussed previously, namely, the diesel and gaseous fuel commands 408 and 410, the diesel pump control signal 412, and the gaseous fuel pump control signal 414, each of which has been appropriately adjusted, for example, proportionally, to the power difference 610, but other or additional parameters may be used.

### INDUSTRIAL APPLICABILITY

The present disclosure is applicable to DIG engines having a gaseous fuel system operating with a liquid fuel system, which is used to provide liquid fuel that ignites the gaseous fuel. In the illustrated embodiment, both fuels are injected directly into each engine cylinder using a dual-check fuel injector. Various sensors are disposed to monitor components and systems of the engine for proper operation, and indications are generated within a controller associated with the system of abnormal operating conditions. When abnormal operating conditions are present, the controller determines the severity of the abnormal condition and adjusts operation of the engine to change to ratio at which the two fuels are supplied. For example, while under normal operation the liquid fuel is primarily used to ignite the gaseous fuel, in a thermal management operating mode such as when cold starting and/or operating the engine in a frigid environment, where insufficient engine heat may be available to heat a sufficient engine supply of liquefied gaseous fuel, the liquid fuel is used to provide engine power that displaces or replaces power normally provided by the gaseous fuel until the engine has had a chance to warm up.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A direct injection gas engine system, comprising:
an engine having at least one cylinder and a cooling system having a coolant;
a gaseous fuel system that includes a heater and a gaseous fuel injector, the heater adapted to heat liquefied gaseous fuel by extracting heat from the coolant and providing the heat to the liquefied gaseous fuel, which the gaseous fuel injector is adapted to inject directly into the at least one cylinder;
a liquid fuel system that includes a liquid fuel injector configured to inject liquid fuel directly into the at least one cylinder;
a coolant temperature sensor disposed to measure a coolant temperature at an outlet of the heater and provide an outlet coolant temperature signal; and
a controller disposed to control the gaseous fuel and the liquid fuel injectors, the controller further disposed to receive and process the outlet coolant temperature signal, such that:
when the outlet coolant temperature signal is above a threshold temperature, the controller commands a normal amount of liquid fuel and a normal amount of gaseous fuel to be injected into the at least one cylinder during a normal engine operating mode, and
when the outlet coolant temperature signal is at or below the threshold temperature, the controller commands an amount of liquid fuel that is larger than the normal amount of liquid fuel and an amount of gaseous fuel that is less than the normal amount of gaseous fuel to be injected into the at least one cylinder, such that the heat extracted from the coolant is reduced during an engine thermal management mode.

2. The engine system of claim 1, wherein the liquid fuel system includes a liquid fuel pump configured to draw the liquid fuel from a liquid fuel reservoir and provide compressed liquid fuel to a liquid fuel rail that is fluidly connected to the liquid fuel injector, the compressed liquid fuel being compressed to a rail pressure and injected into the at least one cylinder via the liquid fuel injector in response to a command from the controller.

3. The engine system of claim 2, wherein the gaseous fuel system includes a cryogenic tank configured to store the gaseous fuel in a liquid state, and wherein the heater brings the gaseous fuel to a supercritical gaseous state.

4. The engine system of claim 3, wherein the gaseous fuel system further comprises a gaseous fuel pump configured to draw liquefied gaseous fuel from the cryogenic tank and provide compressed liquefied gaseous fuel to the heater, and a fuel filter disposed downstream of the heater and adapted to filter the gaseous fuel.

5. The engine system of claim 4, further comprising a pressure control module disposed between the heater and the gaseous fuel injector, the pressure control module configured to control a pressure of the gaseous fuel that is provided to the gaseous fuel injector.

6. The engine system of claim 5, wherein the controller commands the liquid and gaseous fuel amounts based on a difference between the outlet coolant temperature signal and the threshold temperature.

7. The engine system of claim 1, further comprising at least one of:
an additional coolant temperature sensor disposed to measure an inlet coolant temperature to the heater and provide an inlet coolant temperature signal to the controller;
wherein the controller is further disposed to receive the inlet coolant temperature signal, an engine speed signal indicative of a speed of the engine, and an engine load signal indicative of a desired fuel command of the engine; and
wherein the controller is further disposed to:
calculate a desired heating power based on the engine speed and load signals for an engine operating condition;
calculate a measured heating power based on the inlet and outlet coolant temperature signals for the engine operating condition;
compare the desired with the measured heating powers,
operate under the normal engine operating mode when the desired and measured heating powers are substantially equal, and
activate the engine thermal management mode when the desired heating power is greater than the measured heating power.

8. A thermal management system for a direct injection gas engine that uses a diesel pilot to ignite a directly injected gaseous fuel such as liquefied petroleum or natural gas that is stored in a cryogenic tank and is heated in a heater for use in an engine, the heater operating to extract engine heat from engine coolant provided by the engine, the thermal management system operating in a controller associated with the engine, comprising:
a diesel fuel system that includes a diesel fuel rail in fluid communication with a diesel fuel injector, the diesel fuel injector configured to inject diesel fuel directly into an engine cylinder;
a gaseous fuel system that includes a gaseous fuel injector, the gaseous fuel injector configured to inject gaseous fuel directly into the engine cylinder;
a coolant temperature sensor disposed to measure a temperature of engine coolant at a coolant outlet of the heater and provide an outlet coolant temperature signal;
wherein the controller is disposed to receive and process the outlet coolant temperature signal and, based on the outlet coolant temperature signal, control the gaseous fuel and the liquid fuel injectors, such that:
when the outlet coolant temperature signal is above a threshold temperature, the controller commands a normal amount of liquid fuel and a normal amount of gaseous fuel to be injected into the engine cylinder during a normal engine operating mode, and
when the outlet coolant temperature signal is at or below the threshold temperature, the controller commands an amount of liquid fuel that is larger than the normal amount of liquid fuel and an amount of gaseous fuel that is less than the normal amount of gaseous fuel to be injected into the engine cylinder, such that the engine heat extracted from the engine coolant is reduced during an engine thermal management mode.

9. The engine system of claim 8, wherein the diesel fuel system includes a liquid fuel pump configured to draw liquid fuel from a liquid fuel reservoir and provide compressed liquid fuel to a liquid fuel rail that is fluidly connected to the diesel fuel injector, the compressed liquid fuel being compressed to a rail pressure.

10. The engine system of claim 9, wherein the cryogenic tank is configured to store the gaseous fuel in a liquid state.

11. The engine system of claim 10, wherein the gaseous fuel system further comprises a gaseous fuel pump configured to draw liquefied gaseous fuel from the cryogenic tank and provide compressed liquefied gaseous fuel to the heater, and a fuel filter disposed downstream of the heater and adapted to filter the gaseous fuel.

12. The engine system of claim 11, further comprising a pressure control module disposed between the heater and the gaseous fuel injector, the pressure control module configured to control a pressure of the gaseous fuel that is provided to the gaseous fuel injector.

13. The engine system of claim 12, wherein the controller commands the liquid and gaseous fuel amounts based on a difference between the outlet coolant temperature signal and the threshold temperature.

14. The engine system of claim 8, further comprising at least one of:
an additional coolant temperature sensor disposed to measure an inlet coolant temperature to the heater and provide an inlet coolant temperature signal to the controller;
wherein the controller is further disposed to receive the inlet coolant temperature signal, an engine speed signal indicative of a speed of the engine, and an engine load signal indicative of a desired fuel command of the engine; and
wherein the controller is further disposed to:
calculate a desired heating power based on the engine speed and load signals for an engine operating condition;
calculate a measured heating power based on the inlet and outlet coolant temperature signals for the engine operating condition;
compare the desired with the measured heating powers,
operate under the normal engine operating mode when the desired and measured heating powers are substantially equal, and
activate the engine thermal management mode when the desired heating power is greater than the measured heating power.

15. A method for managing thermal energy in an engine, comprising:
operating a gaseous fuel supply system that includes a storage tank adapted to store a gaseous fuel in a cryogenically liquefied state, a gas pump adapted to draw gaseous fuel from the storage tank and compress it to produce compressed gaseous fuel, a heater adapted to increase an enthalpy of the compressed gaseous fuel by supplying heat extracted from an engine cooling system to the gaseous fuel, and a gaseous fuel injector adapted to inject the gaseous fuel directly into an engine cylinder;
monitoring, in a controller, sensor signals indicative of an heating power that is provided to the gaseous fuel through the heater, the sensor signals including at least one of a coolant inlet temperature to the heater, a coolant outlet temperature from the heater, an engine speed and an engine load;
determining in a controller that the heat extracted from the engine is insufficient to increase the enthalpy of the compressed gaseous fuel based on the monitoring of at least one of the sensor signals; and
shifting engine operation by use of the controller from a normal mode to a thermal management mode when insufficient engine heat is present;
wherein, when operating in the normal mode, a normal amount of liquid fuel and a normal amount of gaseous fuel are injected into an engine cylinder to produce a rated engine power, and
when operating in the thermal management mode, an amount of liquid fuel that is larger than the normal amount of liquid fuel and an amount of gaseous fuel that is less than the normal amount of gaseous fuel are injected into the engine cylinder to produce an engine power that is less than or equal to the rated engine power.

16. The method of claim 15, wherein the controller monitors at least a signal indicative of the coolant outlet temperature from the heater, compares it to a threshold temperature, operates in the normal mode when the coolant outlet temperature is greater than the threshold temperature, and operates in the thermal management mode when the coolant outlet temperature is less than or equal to the threshold temperature.

17. The method of claim 15, wherein shifting engine operation from the normal mode to the thermal management mode includes increasing a rail pressure of the liquid fuel and increasing an injection duration of a liquid fuel injector to compensate for the reduction in the amount of gaseous fuel injecting into the engine cylinder.

18. The method of claim 15, wherein determining that the heat extracted from the engine is insufficient includes:
determining an expected heating power in the controller, which is indicative of a thermal power that is required to heating sufficient gaseous fuel to operate the engine;
determining a measured heating power in the controller, which is indicative of a thermal power that is absorbed by the gaseous fuel in the heater;
comparing the expected heating power with the measured heating power and, when the expected and measured heating powers are not substantially equal, adjusting operating parameters of the engine to reduce the expected heating power to match the measured heating power.

19. The method of claim 18, wherein reducing the expected heating power includes altering engine operating parameters to increase a liquid fuel consumption and decrease gaseous fuel consumption of the engine.

20. The method of claim 19, wherein increasing the liquid fuel consumption of the engine includes increasing a liquid fuel pressure in a liquid fuel rail and increasing an injection duration of a liquid fuel injector that is associated with the liquid fuel rail.
